(19) United States
(12) Patent Application Publication
(10) Pub. No.: US 2010/0306136 A1
(43) Pub. Date: Dec. 2, 2010

(54) Pizza Business Model

(76) Inventor: Anthony Goolab, (US)

Correspondence Address: Anthony Goolab, 16 Roman Road, Luton, LU49DN, GB

(21) Appl. No.: 12/774,537

(22) Filed: May 5, 2010

(30) Foreign Application Priority Data
Jun. 1, 2009 (GB) GB0909440.0

(51) Int. Cl. G06Q 90/00

(52) U.S. Cl. 705/500

(57) ABSTRACT

A new, additional or enhanced business model for the business of selling pizzas, which provides customers of the business the ability to communicate via a message on one or more modified pizzas. The business model includes the definition of a message by the customer, and the creation of this message on one or more pizzas.

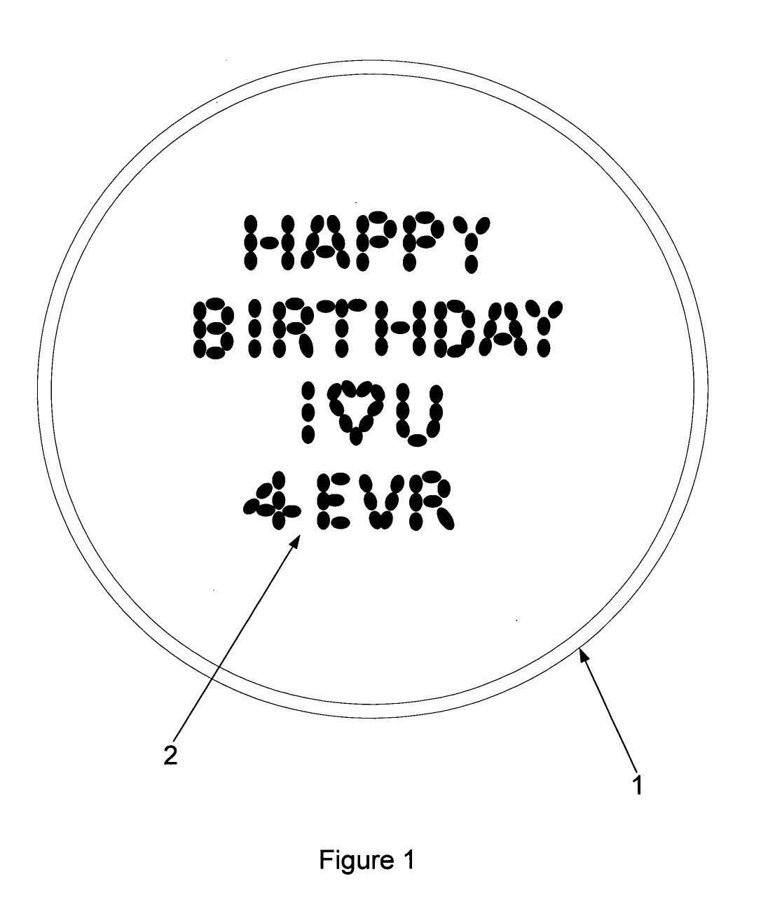

An example of a pizza message can be seen in FIG. 1, where the pizza 1, has the message 2 (“HAPPY BIRTHDAY I♡U 4EVR”) which has been created by the precise arrangement of fragments of olives.

### CROSS-REFERENCE TO RELATED APPLICATIONS

This application claims the benefit of United Kingdom Patent Serial Number: GB0909440.0, filed 2009 Jun. 1 by the present inventor, which is incorporated by reference.

### FEDERALLY SPONSORED RESEARCH

Not applicable

### SEQUENCE LISTING OR PROGRAM

Not applicable

### BACKGROUND

1. Field

This invention relates to the business of selling pizzas, specifically to providing a method of communication via a modified pizza.

2. Discussion of Prior Art

The standard business model for selling pizzas is well known, and utilised worldwide. This standard business model facilitates the placing of an order by a customer for one or more pizzas, followed by the creation of these pizzas and their subsequent collection by, or delivery to, either the customer or a designated recipient. Since the invention of the pizza business this standard business model for selling pizzas has not changed.

### SUMMARY

This invention details a new business model which can be incorporated into any new or existing business that sells pizzas. It does not have to replace the standard business model, but can be used as either an additional or an enhanced business model. This invention provides a method of communication, for the customer, via a message on one or more modified pizzas. This message, as defined by the customer, is created through the manipulation of ingredients on the outer surface of said pizza(s).

### DETAILED DESCRIPTION

### First Embodiment

FIG. 1

Preferred embodiments of the present invention will provide one or more pizzas with a message created through the foregoing processes:

According to one aspect of the present invention as shown in FIG. 1, there is provided one pizza 1 with a message formed by indicia 2, wherein said indicia have been created by the precise arrangement of olives, or fragments of olives, on the top surface of said pizza 1.

### Alternative Embodiment

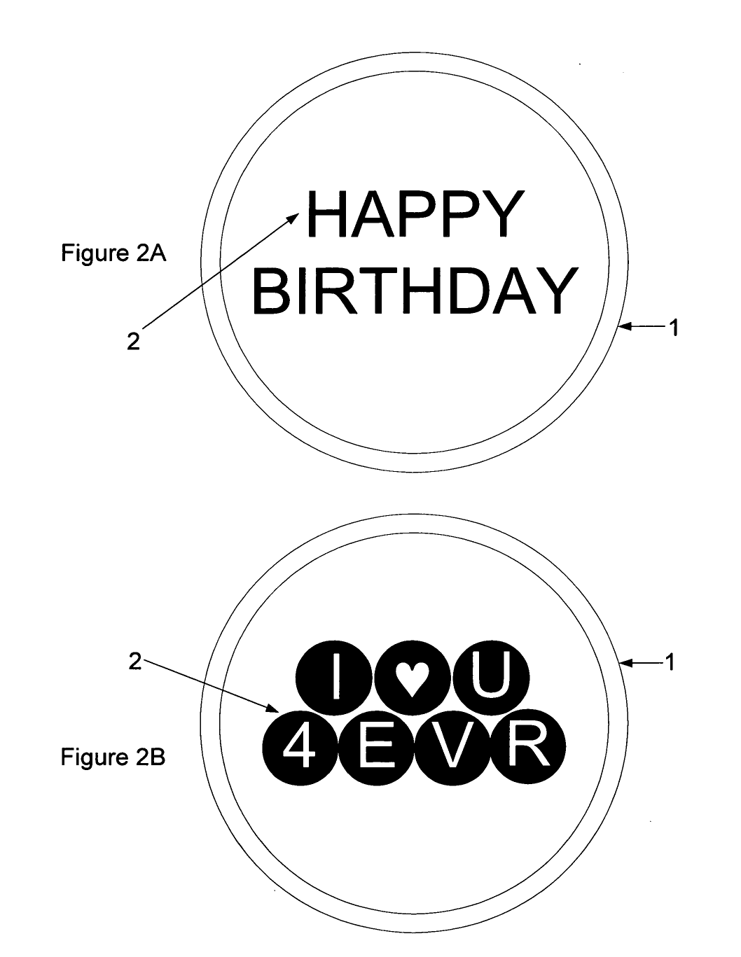

FIG. 2A and FIG. 2B

According to an alternative aspect of the present invention as shown in FIG. 2A and FIG. 2B, there is provided more than one pizza 1, with a message “HAPPY BIRTHDAY” on said pizza formed by indicia 2, wherein said indicia have been created by browning of the surface of cheese, wherein said browning is created by the precise application of heat, and wherein said cheese is placed on the top surface of said pizza, and with a message “I♡U 4EVR” on said pizza formed by indicia 2, wherein said indicia have been created by the cutting out of shapes from slices of salami, wherein said slices of salami are arranged on the top surface of said pizza.

### Alternative Embodiment

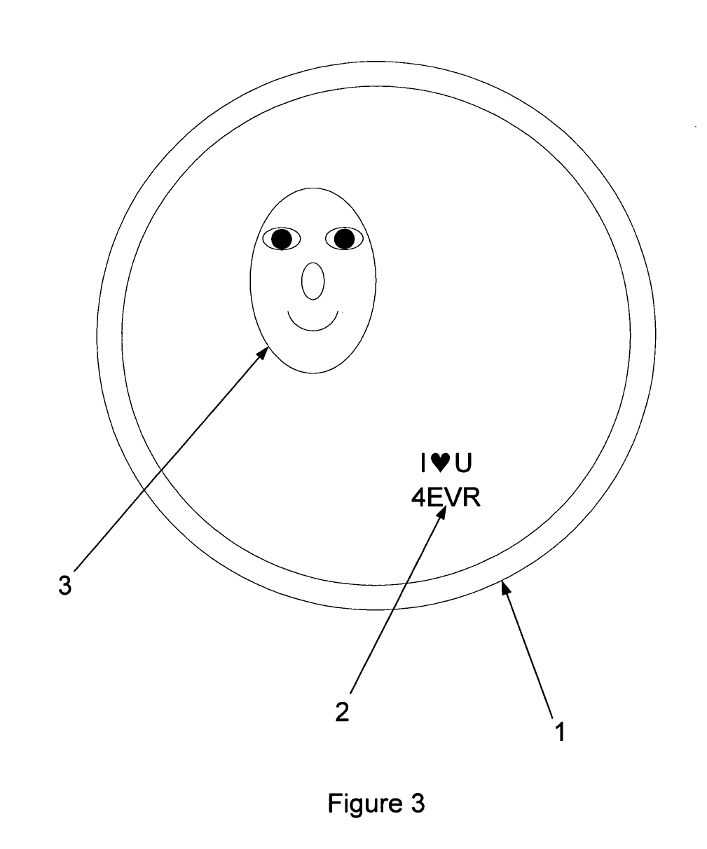

FIG. 3

According to an alternative aspect of the present invention as shown in FIG. 3, there is provided one pizza 1 with a message formed by indicia 2 and 3, wherein said indicia 2 have been created by the precise arrangement of olives, or fragments of olives, on the top surface of said pizza 1, and wherein said indicia 3 have been created by the application of a layer of food dye in the form of a diagram, wherein said food dye has been applied to the top surface of said pizza 1.

Advantages

The benefits to the customer include a fun, surprising, alternative method of communication. The benefits to the business include additional scope for marketing, a novelty advantage over competitors who do not own a license for this invention, and a subsequent increase in sales revenue.

1. A method, used in a business, for communicating a message on one or more pizzas ordered by a customer of said business, whereby said message is conveyed to said business by said customer, and said customer optionally conveys details of an intended recipient of said message on said pizza(s), wherein said method includes the following steps:
a. taking an order from said customer, for said message on said pizza(s);
b. taking the definition of said message from said customer;
c. creating said pizza(s) and manipulating one or more ingredients, to the extent that said ingredient(s) form a selection of indicia on the outer surface of said pizza(s), whereby said indicia define said message on said pizza(s), and whereby said message may be formed on a single pizza of said order, split across more than one pizza of said order, or replicated on multiple pizzas of said order;
d. facilitating the collection or delivery of said message on said pizza(s), for either said customer or said recipient.
